(19) United States
(12) Patent Application Publication
(10) Pub. No.: US 2017/0016250 A1
(43) Pub. Date: Jan. 19, 2017

(54) BISTABLE ELECTROMECHANICAL MAGNETIC LOCKING DEVICE

(71) Applicants: István Andor SÜMEGI, Dunakeszi (HU); Károly MONORI KISS, Budapest (HU)

(72) Inventors: István Andor SÜMEGI, Dunakeszi (HU); Károly MONORI KISS, Budapest (HU)

(21) Appl. No.: 15/123,725

(22) PCT Filed: Feb. 27, 2015
(86) PCT No.: PCT/HU2015/000023

§ 371 Date: Sep. 6, 2016

(30) Foreign Application Priority Data
Mar. 19, 2014 (HU) P1400151

(51) Int. Cl. E05B 47/00; E05B 81/08; E05B 79/20

(52) U.S. Cl. CPC E05B 47/0002; E05B 79/20; E05B 81/08; E05B 47/0038; E05B 2047/0079; E05B 2047/0007

(57) ABSTRACT

An electromagnetically actuated, bistable locking device is disclosed. The locking device has a lock pin that is moveable substantially along a longitudinal axis between an extended position and a retracted position, at least one permanent magnet with two pole ends, at least one electromagnet having first and second ends and electromagnetically actuated in one of the extended and retracted positions of the lock pin, a mechanical interconnection between the pin lock and the at least one permanent magnet for moving said pin lock between the extended and the retracted positions of the lock pin at the actuation of the electromagnet. The inventive idea lies in that if the permanent magnet abuts by one of its faces on the end of the magnetic core of the electromagnetic solenoid, then this configuration allows the exploitation of the magnetic forces at a maximum efficiency in both the energized state and the de-energized state.

The present invention relates to an electromechanically actuated, bistable magnetic locking device for providing two stable end-positions, namely a locking position and a released position, without the application of holding voltage. The field of application of the invention primarily covers the latches or locking assemblies of vehicle casings, and other locking assemblies, mechanical units and machines, wherein locking with two stable end-positions without the application of holding voltage is required.

In the prior art numerous solutions of locking devices are known. These solutions include, for example, the conventional, electromagnetically actuated locking devices that comprise a steel spring. Such a solution is disclosed in the Hungarian utility model application U1100220. This solution has the key feature that upon energization of the electromagnetic solenoid, it attracts a steel pin by overcoming the pressing force of the steel spring, thereby the locking action finishes. After de-energization the steel spring pushes the steel pin back into its initial position, thereby the locking action comes into existence again. A drawback of this solution is that it does not provide two stable end-positions for the locking device without the application of holding voltage.

In another known solution, no steel spring is used for locking, but an electromagnetic solenoid and a permanent magnet are used instead. Such a solution is disclosed in the Hungarian patent application P1000449, wherein in an idle, voltage-free state there is an attraction force between the electromagnetic solenoid and the permanent magnet of the locking device, thereby providing a locking action. After appropriately energizing the electromagnetic solenoid, a repulsive force develops between the electromagnetic solenoid and the permanent magnet of the locking device, thereby the locking action finishes. After de-energization, a magnetic attraction force comes to existence again between the electromagnetic solenoid and the permanent magnet and the locking action is thereby recovered. A drawback of this solution is that without the application of a holding voltage it cannot provide two stable end-positions for the locking device.

There are also known other solutions in which two stable end-positions without the application of holding voltage are provided by means of an electromotor and various spindle driving gears. Such solutions include, for example, the actuating mechanism of a vehicle central lock. A similar solution is disclosed in the published document WO2011120719, wherein the two stable end-positions of locking in absence of holding voltage is provided by means of a spindle drive gear actuated by an electromotor. These solutions, however, have a complicated construction and a substantial space demand.

There are also other known solutions in which the magnetic force interaction between the electromagnetic solenoid and the permanent magnet is exploited to provide two stable end-positions. Such a solution is disclosed in the document EP1953774A2, wherein the electromagnetic solenoid and the permanent magnet are arranged relatively to each other in so manner that after the energization of the electromagnetic solenoid, the permanent magnet turns away 90 degrees around an axis perpendicular to the direction of the locking action, and the locking effect is achieved through a complicated mechanical interconnection. Upon reversing the polarity of the voltage, a non-locking or released state is produced. This solution has the drawback that it has a complicated construction and it operates inefficiently.

The disadvantage of the above introduced prior art solutions is that they do not have two stable end-positions, i.e. a released or non-locking position and a locking position, without the application of holding voltage. Due to the electromotor and the spindle drive gear, their mechanical construction is complicated and they can be utilized at a larger, industrial scale only with higher costs. Due to the arrangement of the electromagnetic solenoid and the permanent magnet, as a result of the limited 90-degree range of rotation, the magnetic force can act only with a loss. The complicated mechanical interconnection leads to uncertain operation and higher energy consumption.

It is therefore an object of the present invention to provide an electromagnetically actuated, bistable locking device with two stable end-positions, i.e. a non-locking or released position and a stable locking position, without the application of holding voltage. Another object of the invention is to provide a locking device that has a simple construction, operates efficiently, and allows an easy planning of its industrial application, and that provides optimal, stable and highly reliable operation. Yet another object of the invention is to replace the complicated locking devices comprising a spindle drive gear actuated by an electromotor and also to replace the complicated, less efficient bistable locking devices, as well as the locking devices having only one stable end-position in absence of the conventional holding voltage.

The inventive idea lies in that if the permanent magnet abuts by one of its faces on the end of the magnetic core of the electromagnetic solenoid, then this configuration allows the exploitation of the magnetic forces at a maximum efficiency in both of the energized state and the de-energized state. In the voltage-free state, there is a magnetic attraction force between the magnetic core of the electromagnetic solenoid and the permanent magnet, thereby they stably lean against each other, thus producing a stable end-position in the locking state. When the electromagnetic solenoid is energized by direct voltage with an appropriate polarity, a repulsive force between the electromagnetic solenoid and the permanent magnet comes to existence with overcoming the magnetic attraction force therebetween. The permanent magnet is mounted on a rotating crank-shaft. The lock pin providing the locking action is coupled to one crank of the crank-shaft. The repulsive force or the attraction force of the electromagnetic solenoid causes the permanent magnet to turn away 180 degrees, thereby rotating the crank-shaft with the permanent magnet mounted thereon along its longitudinal axis, whereby the polarity of the permanent magnet facing towards the electromagnetic solenoid becomes reversed. In this situation a magnetic attraction force develops between the electromagnetic solenoid and the permanent magnet and they stably lean against each other. If in this state, the locking device is de-energized, the magnetic attraction force between the permanent magnet and the magnetic core of the solenoid still remains, thereby another stable end-position without a locking action is established. It has been also recognized that when two electromagnetic solenoids and two permanent magnets are applied with corresponding polarities and poles, even more advantageous and more efficient operation may be achieved.

The above objects are achieved by providing an electromagnetically actuated, bistable locking device comprising:
a lock pin adapted to move substantially along a longitudinal axis between an extended position and a retracted position,
at least one permanent magnet with two pole ends, said at least one permanent magnet mounted for rotation between a first magnetic orientation associated with an extended position of the lock pin and a second magnetic orientation associated with a retracted position of the lock pin,
at least one electromagnet having first and second ends and electromagnetically actuated in one of said extended and retracted positions of the lock pin to provide a first orientation of magnetic field, and in the other of said extended and retracted positions of the lock pin to provide a second orientation of magnetic field, said second orientation of magnetic field being substantially the reverse of the first orientation of the magnetic field,
a mechanical interconnection between the pin lock and the at least one permanent magnet for moving said pin lock between the extended and the retracted positions of the lock pin at the actuation of the electromagnet, and
wherein each of the at least one permanent magnet is arranged adjacent to the first end of the respective one of the at least one electromagnet.

The locking device is characterized in that the mechanical interconnection comprises a rotatable crank-shaft extending perpendicularly to said longitudinal axis of the lock pin, and to which the at least one permanent magnet is rigidly mounted, said crank-shaft having at least one eccentric section to which the lock pin is pivotably coupled, and that the device further comprises guiding means for guiding the lock pin substantially along said longitudinal axis.

Preferably, the locking device comprises two electromagnetic solenoids arranged side by side, wherein a permanent magnet is arranged at the first end of both electromagnetic solenoids, and wherein the electromagnetic solenoids are connected to each other with reverse polarity, and wherein the two permanent magnets are mounted to the crank-shaft with reverse magnetic polarity.

The locking device preferably comprises a steel shielding housing having an aperture for allowing the ejection of the lock pin.

In a preferred embodiment of the locking device according to the invention, the at least one electromagnetic solenoid is fastened to the shielding housing, and the crank-shaft is adapted to move in a guided manner, in parallel to the longitudinal axis of the lock pin.

In another preferred embodiment of the locking device according to the invention, the at least one electromagnetic solenoid is adapted to move in a direction parallel to the longitudinal axis of the lock pin and the rotational axis of the crank-shaft is stationary.

The electromechanically actuated, bistable magnetic locking device according to the invention will now be described in detail with reference to the drawings, in which:

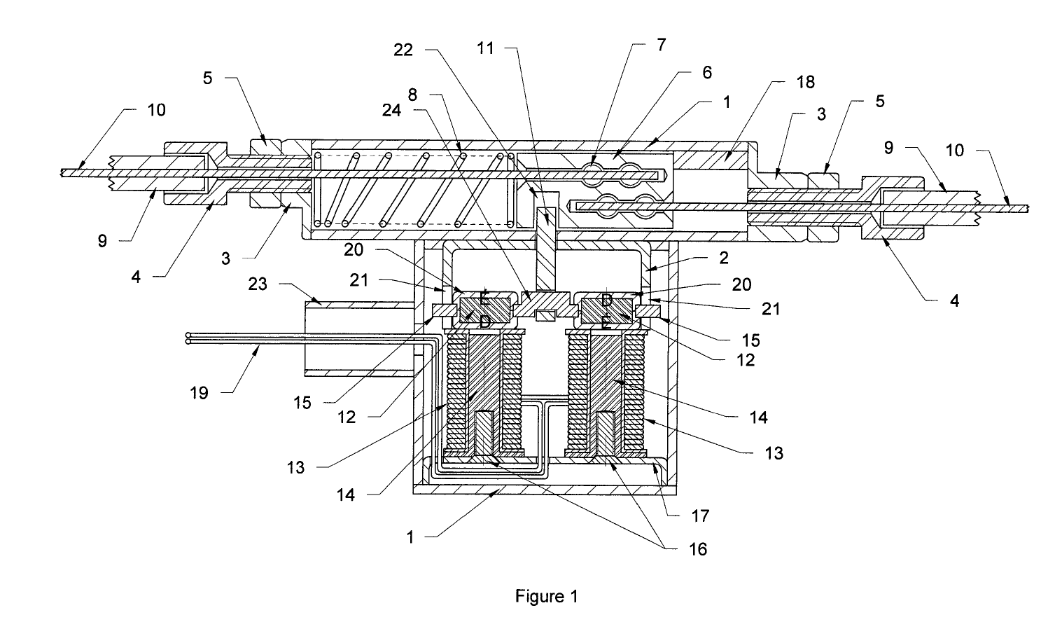

FIG. 1 illustrates an exemplary application of the electromechanically actuated, bistable magnetic locking device according to the invention in front view, in a voltage-free idle state when the lock pin is in an extended position.

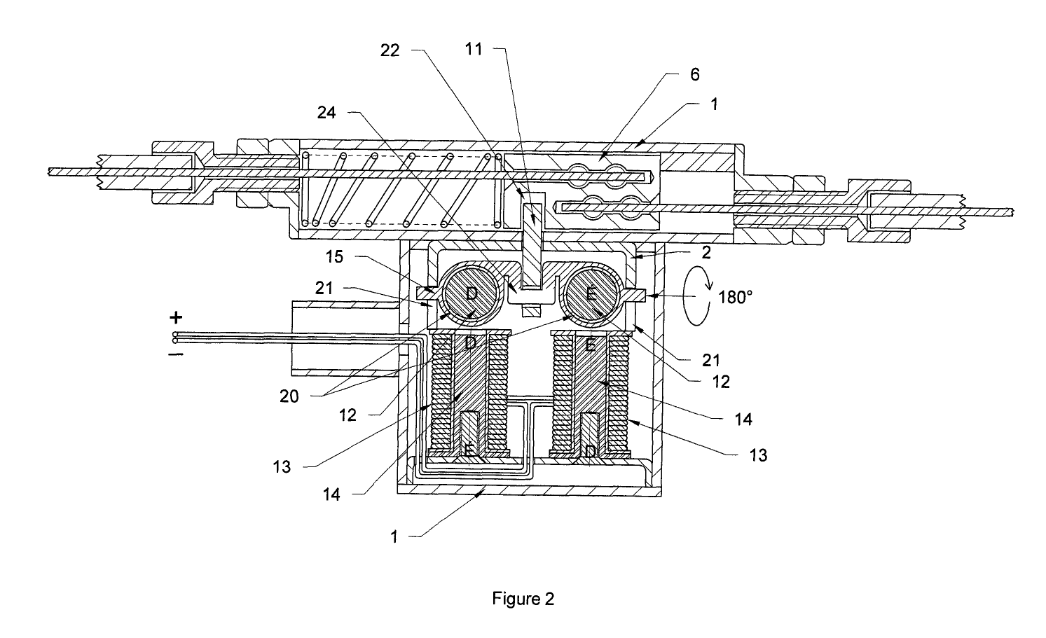

FIG. 2 illustrates an exemplary application of the locking device according to the invention in front view in the middle of the releasing phase, the device being energized by direct voltage.

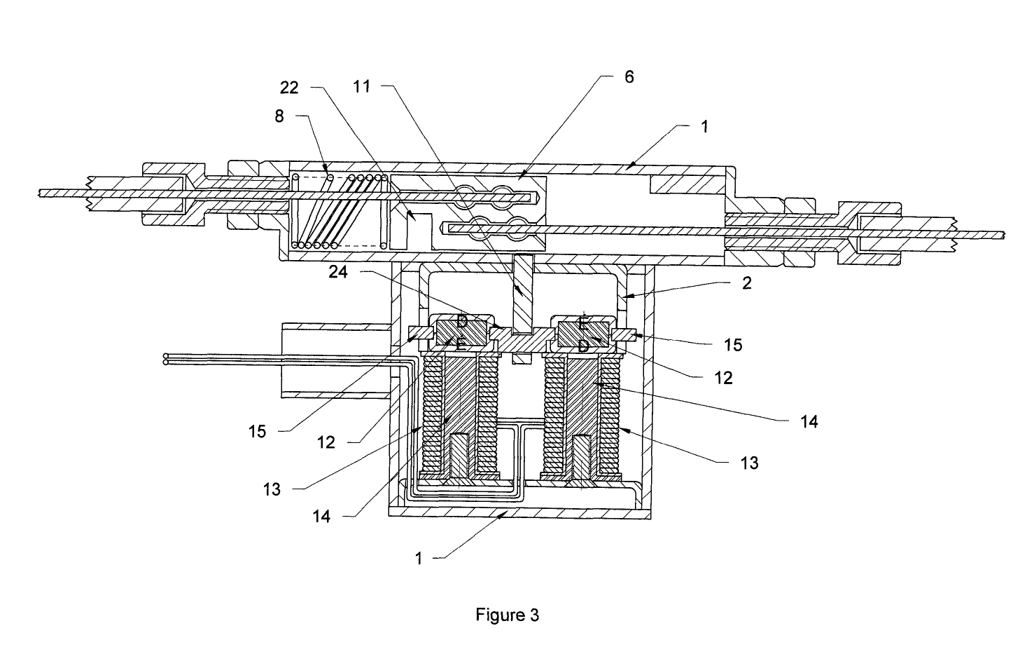

FIG. 3 illustrates an exemplary application of the locking device according to the invention in front view in a voltage-free state, the device being in a released or non-locking state.

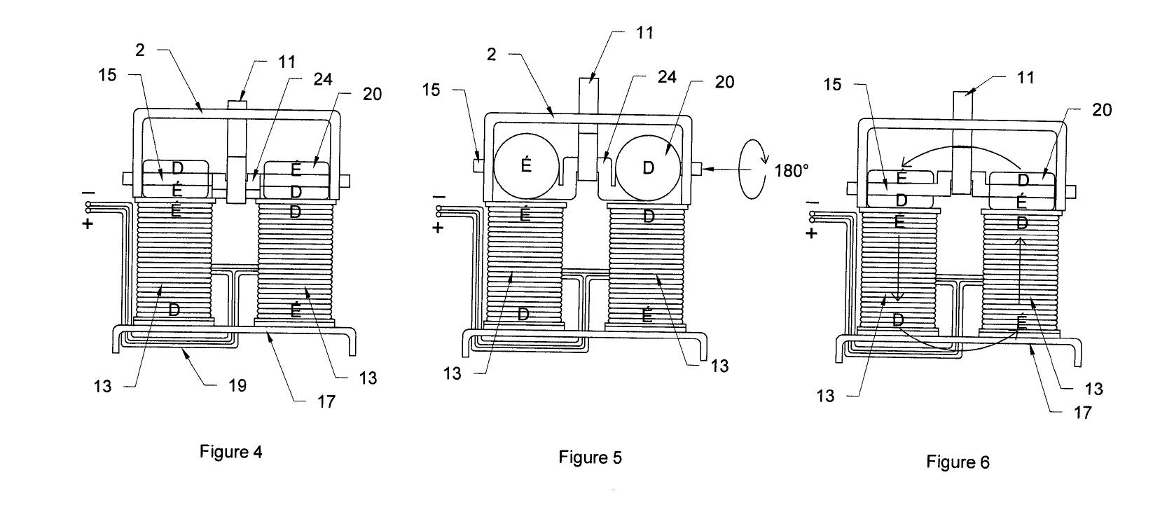

FIG. 4 illustrates a preferred embodiment of the locking device according to the invention in front view at the beginning of the locking phase, the device being energized by direct voltage.

FIG. 5 is a front view of the embodiment of the locking device according to the invention as shown in FIG. 4, the device being in the middle of the locking phase and energized by direct voltage.

FIG. 6 is front view of the embodiment of the locking device according to the invention as shown in FIG. 4, the device being in the locking phase and energized by direct voltage.

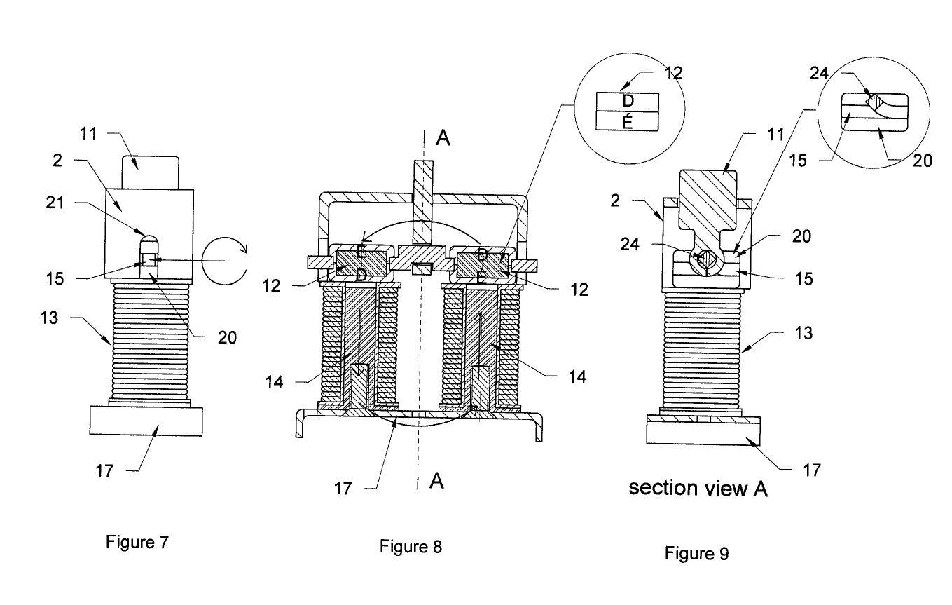

FIG. 7 is a side view of the embodiment of the locking device according to the invention as shown in FIG. 4, the device being in an idle locking state under voltage-free condition.

FIG. 8 is a front sectional view of the embodiment of the locking device according to the invention as shown in FIG. 4, the device being in an idle locking state under voltage-free condition.

FIG. 9 illustrates the embodiment of the locking device according to the invention as shown in FIG. 4, in a side cross-sectional view along A-A, the device being in an idle locking state under voltage-free condition.

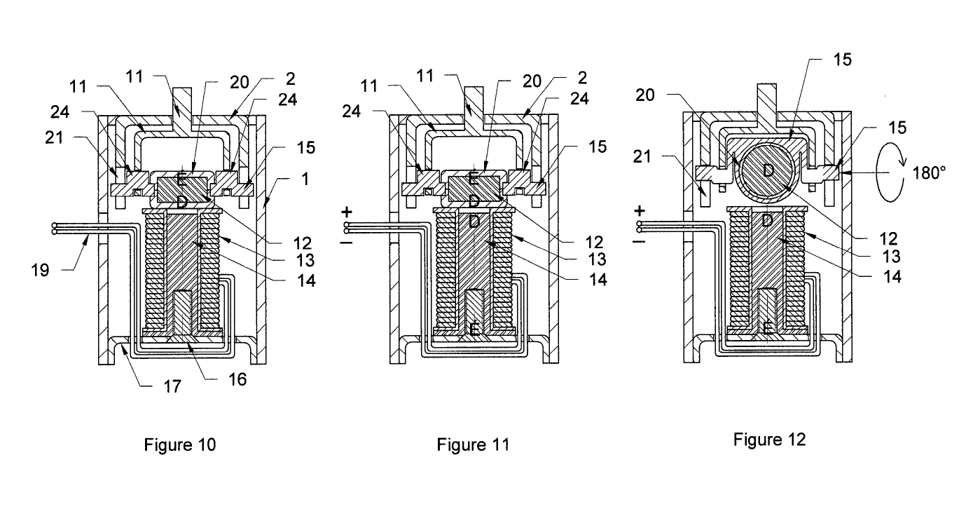

FIG. 10 illustrates a second embodiment of the locking device according to the invention in front view, the device being in an idle locking state under voltage-free condition.

FIG. 11 is a front sectional view of the second embodiment of the locking device according to the invention as shown in FIG. 10, the device being at the beginning of the releasing phase and energized by direct voltage.

FIG. 12 is a front sectional view of the second embodiment of the locking device according to the invention as shown in FIG. 10, the device being in the middle of the releasing phase and energized by direct voltage.

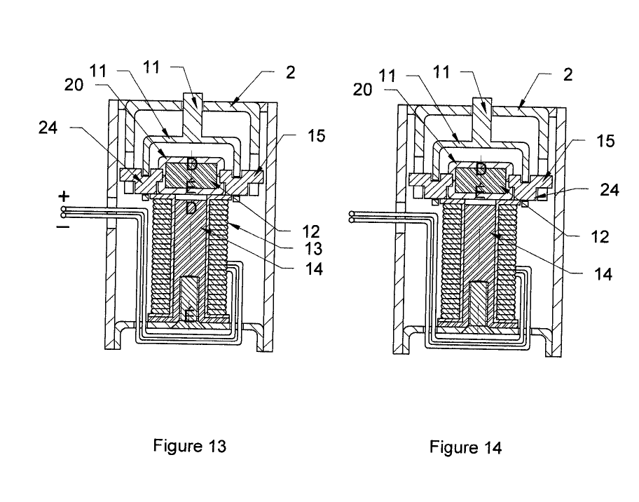

FIG. 13 is a front sectional view of the second embodiment of the locking device according to the invention as shown in FIG. 10, the device being at the beginning of the releasing phase and energized by direct voltage.

FIG. 14 is a front sectional view of the second embodiment of the locking device according to the invention as shown in FIG. 10, the device being in an idle non-locking or released state under voltage-free condition.

In FIG. 1, an example of a preferred application of a first embodiment of the electromechanically actuated, bistable magnetic locking device according to the invention is shown in front sectional view when the device is in a locked, voltage-free state, wherein the housing 1 of the locking device is provided at both of its ends with a terminal socket 3, each socket having a through-hole in which a Bowden adjustment screw 4 is arranged. The Bowden adjustment screws 4 are equipped with counter screw nuts 5. A Bowden wire 10 equipped with a Bowden casing 9 is led through said Bowden adjustment screw 4 and the associated counter screw nut 5. Between the cut ends of the Bowden wire 10, a sliding member 6 is interposed by means of threaded fastening through-holes 7. The sliding member 6 with a compression spring 8 at its one end and a backstop 18 at its other end is arranged within the housing 1 of the locking device. In the lower part of the housing 1 of the locking device, a supporting bracket 17 is arranged to which the magnetic cores of the electromagnetic solenoids 14 are mounted by fastening screws 16. In this embodiment, the locking device comprises two electromagnets 13 arranged side by side, and each one of the two electromagnets 13 is provided with a permanent magnet 12 at its end adjacent to the lock pin 11. The electromagnetic solenoids 13 are connected to each other with reverse electrical polarity. A permanent magnet 12 which is accommodated in a magnet casing 20 mounted on the crank-shaft 15 abuts on one end of the electromagnetic solenoids 13, wherein the ends of the permanent magnets 12 facing towards the electromagnetic solenoids 13 have reverse poles as shown in the Figure by the reference signs É (north) and D (south). The lock pin 11 is pivotably coupled to an eccentric crank 24 of the crank-shaft 15, said lock pin 11 extending through a guide clip 2 and a guiding aperture formed in the housing 1 of the locking device. In this state, the lock pin 11 is received in a recess 22 of the sliding member. Now the lock pin 11 is in an entirely extended position. The ends of the crank-shaft 15 are accommodated in a guiding slot 21 formed in the guide clip 2 in parallel to the longitudinal axis of the lock pin 11. The guide clip 2 is mounted to the housing 1 of the locking device. The electric wires 19 of the electromagnetic solenoids 13 are led out through an outlet tube 23 which is also mounted to the housing 1 of the locking device.

In FIG. 2, the electromechanical bistable magnetic locking device according to the invention is illustrated in front sectional view when the device is in the middle of the releasing phase and energized by direct voltage, wherein the electromagnetic solenoids 13 are energized by direct voltage with reverse polarities relative to each other as indicated by É (north) and D (south) in the figure. The ends of the crank-shaft 15 stay at an upper extremity of the guiding slot 21, and the crank-shaft 15 is turned away by 90 degrees around its longitudinal axis together with the permanent magnets 12 accommodated in the magnet casings 20. The permanent magnets 12 are arranged with reverse poles as indicated by É (north) and D (south) in the figure. Between the magnetic cores 14 of the electromagnetic solenoids and the permanent magnets 12 there is a magnetic repulsive force while on the opposite side of the permanent magnets 12, a magnetic attraction force acts since the polarities of the magnetic cores 14 of the electromagnetic solenoids have not changed. The direction of rotation and the entire inversion by 180 degrees are also depicted in the figure. The pin lock 11 is coupled to the crank 24 of the crank-shaft 15, said pin lock 11 extending through the guide clip 2 and the guiding aperture formed in the housing 1 of the locking device, The lock pin is now intrudes into the recess 22 of the sliding member.

In FIG. 3, the electromechanical bistable magnetic locking device according to the invention is illustrated in front sectional view when the device is in a non-locking, voltage-free state, wherein the electromagnetic solenoids 13 are de-energized, and between the electromagnetic solenoids 13 and the permanent magnets 12 the magnetic attraction force still exists. The crank-shaft 15 has already turned away by 180 degrees around its longitudinal axis due to the magnetic repulsive and attraction forces. The pole ends of the permanent magnets 12 have reversed polarities as compared to their polarities shown in FIG. 1, and the respective end surfaces of the permanent magnets 12 face towards the respective magnetic cores 14 of the electromagnetic solenoids, wherein the polarities are indicated by É (north) and D (south) in the figure. The lock pin 11 coupled to the crank 24 of the crank-shaft 15 extends through a guiding hole of the guide clip 2 and through the guiding aperture formed in the housing 1 of the locking device in so manner that it does not intrudes into the recess 22 of the sliding member. The lock pin 11 is in an entirely retracted position. The sliding member 6 pushes the compression spring 8 and it is displaced into a releasing position inside the housing 1 of the locking device.

In FIG. 4, the first embodiment of the electromechanical bistable magnetic locking device according to the invention in itself is illustrated in front view when the device is at the beginning of the locking phase and energized by direct voltage, wherein the electromagnetic solenoids 13 are mounted on a supporting bracket 17 and fed via electric wires 19. The electromagnetic solenoids 13 are energized with direct voltage with a polarity producing a magnetic repulsive force between the electromagnetic solenoids 13 and the permanent magnets 12. The ends of the electromagnetic solenoids 13 have reverse polarities with respect to each other as indicated by É (north) and D (south) in the figure. The permanent magnets 12 accommodated in the magnet casings 20 mounted to the crank-shaft 15 lean against the ends of the electromagnetic solenoids 13. The polarities of the permanent magnets 12 are reverse relative to each other as indicated É (north) and D (south) in the figure. The crank 24 of the crank-shaft 15 is in its lower position. The lock pin 11 is pivotably coupled to the crank 24 and extends through the aperture of the guide clip 2. Now the lock pin 11 is an entirely retracted position.

In FIG. 5, the electromechanical bistable magnetic locking device according to the embodiment shown in FIG. 4 is illustrated in front view, when the device is in the middle of the locking phase and energized by direct voltage, wherein the electromagnetic solenoids 13 have reverse polarities with respect to each other, said polarities indicated by É (north) and D (south) in the figure. The ends of the crank-shaft 15 are located at the upper extremity of the guiding slot 21 and the crank-shaft 15 is turned away by 90 degrees around its longitudinal axis according to an intermediate state. The crank-shaft 15 holds the permanent magnets 12 accommodated in the magnet casings 20 mounted thereto, said permanent magnets having reverse polarities indicated by É (north) and D (south) in the figure. Between the magnetic cores 14 of the electromagnetic solenoids and the permanent magnets 12 there is a magnetic repulsive force while on the opposite sides of the permanent magnets, 12 a magnetic attraction force acts since the polarity of the magnetic cores 14 of the electromagnetic solenoids has not changed. The direction of rotation and the entire inversion by 180 degrees are also depicted in the figure. The lock pin 11 is coupled to the crank 24 of the crank-shaft 15 and extends through an aperture formed in the guide clip 2.

In FIG. 6, the electromechanical bistable magnetic locking device according to the embodiment shown in FIG. 4 is illustrated in front view, when the device is in a locking stage and energized by direct voltage, wherein the electromagnetic solenoids 13 have reverse polarities with respect to each other as indicated by É (north) and D (south) in the figure. The permanent magnets 12 are accommodated in the magnet casings 20 mounted to the crank-shaft 15, said permanent magnets 12 having reverse polarities with respect to each other as indicated by É (north) and D (south) in the figure. The crank-shaft 15 has already turned away by 180 degrees around its longitudinal axis due to the magnetic attraction force. The crank 24 of the crank-shaft 15 and the lock pin 11 are in their upper locking position. Between the electromagnetic solenoids mounted to the supporting bracket 17 and the permanent magnets 12 there is a magnetic attraction force as indicated by the arrows in the figure. Now the lock pin 11 is in an entirely extended position for locking.

In FIG. 7, the first embodiment of the electromechanical bistable magnetic locking device according to the invention is illustrated in side view, the device being in an idle, voltage-free, locking state, wherein one end of the electromagnetic solenoids 13 is mounted to the supporting bracket 17. The magnetic casings 20 mounted to the crank-shaft 15 abut on the other end of the electromagnetic solenoids 13. The ends of the crank-shaft 15 are received in the guiding slot 21 formed in the guide clip 2. Now the lock pin 11 is in an entirely extended position for locking. In side view, the electromagnetic solenoids 13 are preferably offset with respect to the longitudinal central axis of the locking device, thereby the rotational direction of the crank-shaft 15 is always opposite to the direction of the offset. The direction of rotation is indicated in the figure.

In FIG. 8, the electromagnetic solenoids, the magnetic cores and the fastening screws of the electromagnetic solenoids, the supporting bracket, the crank-shaft, the magnetic casings, the lock pin and the guide clip of the electromechanically actuated, bistable magnetic locking device according to the invention as shown in FIG. 7 are illustrated in an idle, voltage-free locking state, wherein between the magnetic cores 14 of the electromagnetic solenoids, which are mounted to the supporting bracket 17, and the permanent magnets 12 there is a magnetic attraction force as indicated by the arrows. The poles of the permanent magnets 12 are indicated by É (north) and D (south) in the figure.

In FIG. 9, the electromagnetic solenoids, the supporting bracket, the crank-shaft, the magnetic casings, the lock pin and the guide clip of the electromechanically actuated, bistable magnetic locking device as shown in FIG. 7 are illustrated in side sectional view along A-A, the device being in a voltage-free locking state, wherein the magnetic casings 20 mounted to the crank-shaft 15 abut on the respective ends of the electromagnetic solenoids 13 mounted to the supporting bracket 17. The lock pin 11 is coupled to the crank 24 of the crank-shaft 15 by means of a through-hole formed therein. The lock pin Ills guided through an aperture formed in the guide clip 2. The electromagnetic solenoids 13 are arranged offset with respect to the longitudinal axis of symmetry.

In FIG. 10, a second embodiment of the electromechanical bistable magnetic locking device according to the invention is illustrated in front sectional view in a non-locking, idle, voltage-free state. In this embodiment the device comprises only one electromagnetic solenoid 13 with a magnetic core, a supporting bracket with a fastening screw, a crank-shaft with a magnetic casing, a lock pin, a guide clip and an electric wire, wherein the supporting bracket 17 is arranged in the lower part of the housing 1 of the locking device. The magnetic core 14 of the electromagnetic solenoid is mounted to the supporting bracket 17 by means of a fastening screw 16. The permanent magnet 12 accommodated in the magnet casing 20 mounted to the crank-shaft 15 leans on the other end of the electromagnetic solenoid 13. The poles of the permanent magnet 12 are indicated by É (north) and D (south) in the figure. The ends of the crank-shaft 15 are received in the guiding slot 21 of the guide clip 2. The lock pin ills coupled to the crank 24, said lock pin 11 extending through an aperture formed in the guide clip 2. Now the crank 24 of the crank-shaft 15 and the lock pin 11 are in an entirely extended position, i.e. in the upper locking position. The electromagnetic solenoid 13 has an electric wire 19.

In FIG. 11, the electromechanical bistable magnetic locking device according to the embodiment of the invention shown in FIG. 10 is illustrated in front sectional view, the device being in a locking state at the beginning of the releasing phase and energized by direct voltage, wherein the electromagnetic solenoid 13 is energized by direct voltage via the electric wire 19 with a polarity which produces a magnetic repulsive force between the electromagnetic solenoid 13 and the permanent magnet 12. The polarity of the electromagnetic solenoid 13 is indicated by É (north) and D (south) in the figure. The magnetic casing 20 mounted to the crank-shaft 15 with the permanent magnet 12 in it leans on the other end of the electromagnetic solenoid 13, the poles of the permanent magnet being indicated by É (north) and D (south) in the figure. The crank 24 of the crank-shaft 15 is in its lower position and the lock pin 11 is coupled thereto, said lock pin 11 extending through an aperture formed in the guide clip 2.

In FIG. 12, the electromechanical bistable magnetic locking device according to the embodiment of the invention shown in FIG. 10 is illustrated in front sectional view, the device being energized by direct voltage at the beginning of the releasing phase, wherein the polarity of the electromagnetic solenoid 13 is indicated by É (north) and D (south) in the figure. The ends of the crank-shaft 15 are at the upper extremity of the guiding slot 21 and the crank-shaft 15 is turned away by 90 degrees around its longitudinal axis, thereby staying in an intermediate stage. The crank-shaft 15 holds the magnetic casing 20 with the permanent magnet 12 accommodated therein, wherein the poles of the permanent magnet are indicated by E (north) and D (south) in the figure. Between the magnetic core 14 of the electromagnetic solenoid and the permanent magnet 12 there is a magnetic repulsive force while on the opposite side of the permanent magnet 12, a magnetic attraction force acts since the polarity of the magnetic core 14 of the electromagnetic solenoid has not changed. The direction of rotation and the entire inversion by 180 degrees are indicated in the figure.

In FIG. 13, the electromechanical bistable magnetic locking device according to the embodiment of the invention shown in FIG. 10 is illustrated in front sectional view, the device being in a locking state in a releasing phase and energized by direct voltage, wherein the polarity of the electromagnetic solenoid 13 is indicated by É (north) and D (south) in the figure. The poles of the permanent magnet 12 are indicated by É (north) and D (south) in the figure. The crank-shaft 15 has turned away by 180 degrees around its longitudinal axis due to the magnetic repulsive and attraction forces. The magnetic casing 20 holding the permanent magnet 12 leans on the magnetic core 14 of electromagnetic solenoid and there is a magnetic attraction force therebetween. The crank 24 of the crank-shaft 15 and the lock pin 11 are in an entirely retracted position, i.e. in a lower, non-locking position. The lock pin 11 intrudes into the aperture formed in the guide clip 2.

In FIG. 14, the electromechanical bistable magnetic locking device according to the embodiment of the invention shown in FIG. 10 is illustrated in front sectional view, the device being in a non-locking or released state under a de-energized, idle condition, wherein the magnetic casing 20 holding the permanent magnet 12 leans on the magnetic core 14 of electromagnetic solenoid and there is a magnetic attraction force therebetween. The crank 24 of the crank-shaft 15 and the lock pin 11 are in an entirely retracted position, i.e. in a lower, non-locking or released state. The lock pin 11 intrudes into an aperture of the guide clip 2.

As described above, under a voltage-free condition there is a magnetic attraction force between the magnetic core 14 of the one or more electromagnetic solenoids and the one or more permanent magnets 12, thereby they stably lean on each other, thus producing a stable end-position in the locking state. When two electromagnetic solenoids 13 are used, the electromagnetic solenoids are electrically connected to each other with a reverse polarity. When the electromagnetic solenoid 13 are energized by direct voltage with an appropriate polarity, a magnetic repulsive force develops between the magnetic cores 14 of the electromagnetic solenoids and the permanent magnets 12, which magnetic repulsive force overcomes the magnetic attraction force. The permanent magnets 12 are rigidly mounted to the crank-shaft 15, wherein the permanent magnets 12 are oriented with reverse polarities towards the ends of the electromagnetic solenoids 13. The lock pin 11 is coupled to the crank 24 of the crank-shaft 15, said lock pin providing the locking itself. In the above described embodiments, the crank-shaft 15 is guided in parallel to the longitudinal axis of the lock pin 11 by means of a guiding slot 21 formed in the guide clip 2 and thereby it is forced to move in a guided manner. When the magnetic repulsive or attraction force causes the crank-shaft 15 to turn away by 180 degrees, the magnetic forces rotate the crank-shaft by 180 degrees around its longitudinal axis together with the permanent magnets 12 mounted thereon. As a result, the poles of the permanent magnets 12 facing towards the electromagnetic solenoids 13 oppositely change. Then a magnetic attraction force comes to existence between the magnetic cores 14 of the electromagnetic solenoids and the permanent magnets 12, thereby they lean on each other. When the energization finishes, another stable end-position is produced in the non-locking state, wherein the lock pin 11 is in an entirely retracted position. If the electromagnetic solenoids 13 are again energized by the application of direct voltage with a new polarity reverse to the previous one, the process will be repeated and the device will get into a locking state again. Under voltage-free condition, there is a magnetic attraction force between the magnetic cores 14 of the electromagnetic solenoids and the permanent magnets 12, which magnetic attraction force produces a stable engagement in both end-positions. In side view, the electromagnetic solenoids 13 preferably have a minor offset with respect to the symmetry line, therefore the direction of rotation of the crank-shaft 15 holding the permanent magnets thereon is always opposite to the direction of the offset.

When instead of two electromagnetic solenoids 13 and two permanent magnets 12, only one electromagnetic solenoid 13 and one permanent magnet 12 are used, under a voltage-free condition there is a magnetic attraction force between the magnetic core 14 of the electromagnetic solenoid and the permanent magnet 12, thereby they stably lean on each other to produce a stable end-position in the locking state. When the electromagnetic solenoids 13 are energized by the application of direct voltage with appropriate polarity, a magnetic repulsive force, which overcomes the magnetic attraction force, comes to existence between the electromagnetic solenoid 13 and the permanent magnet 12. The permanent magnet 12 is mounted on the crank-shaft 15, and the lock pin 11 is coupled to the crank 24 of the crank-shaft 15 to provide the locking action. In the above described second embodiment, the crank-shaft 15 is guided in parallel to the longitudinal axis of the lock pin 11 by means of a guiding slot 21 formed in the guide clip 2 and thereby it is forced to move in a guided manner. When the magnetic repulsive or attraction force causes the crank-shaft 15 to turn away by 180 degrees, the magnetic forces rotate the crank-shaft by 180 degrees around its longitudinal axis together with the permanent magnet 12 mounted thereon. As a result, the poles of the permanent magnet 12 facing towards the electromagnetic solenoid 13 oppositely change. Then a magnetic attraction force comes to existence between the magnetic core 14 of the electromagnetic solenoid and the permanent magnet 12, thereby they lean on each other. When the energization finishes, another stable end-position is produced in the non-locking state, wherein the lock pin 11 is in an entirely retracted position. If the electromagnetic solenoid 13 is again energized by the application of direct voltage with a new polarity reverse to the previous one, the process will be repeated and the device will get into a locking state again. Under voltage-free condition, there is a magnetic attraction force between the magnetic core 14 of the electromagnetic solenoid and the permanent magnet 12, which magnetic attraction force produces a stable engagement in both end-positions. In side view, the electromagnetic solenoid 13 preferably has a minor offset with respect to the symmetry line, therefore the direction of rotation of the crank-shaft 15 holding the permanent magnet is always opposite to the direction of the offset.

Hereinabove two embodiments of the locking device according to the invention were described with reference to the drawings, wherein the one or two electromagnets are mounted to the supporting bracket of the device, and wherein the crank-shaft moves in parallel to the longitudinal axis of the lock pin in a guided manner when the magnets are inverted, thereby allowing the permanent magnets with flat contact surfaces to freely turn away. It is obvious for a skilled person that if the contact surfaces of the permanent magnets are not flat but arcuate (whereby they do not lean on the end surfaces of the magnetic cores of the electromagnets) or if a small gap is kept between the pole ends of the permanent magnets and the end surfaces of the magnetic cores, then it will not be necessary to allow the crank-shaft to move in a direction parallel to the longitudinal axis of the lock pin, so the crank-shaft may be mounted so that it can rotate in place.

Although it is not shown in the drawings, it is obvious for a skilled person that when the permanent magnets have flat contact surfaces (whereby they can lean on the end surfaces of the magnetic cores of the electromagnets), the permanent magnets can be rotated in such a way that the rotational axis of the crank-shaft is stationary and the electromagnets are arranged so that they can move along a direction parallel to the longitudinal axis of the lock pin. In this case the displacement of the electromagnets with respect to the supporting bracket is described, for example, in the document P1000449, wherein a compression spring is inserted between the other end of the electromagnets and the supporting bracket.

An advantage of the present invention is that it can provide two stable end-positions without the application of holding voltage; one in the non-locking or released state and another one in the locking state even. In the released state, the lock pin is in an entirely retracted position, whereas in the locking state, the lock pin is in an entirely extended position. The structural arrangement and the construction of the device are very simple and efficient. The device is easy to use in an industrial application, it has optimal and stable operation and high reliability. It is suitable for replacing the complicated locking devices comprising a spindle drive gear driven by an electromotor, and it also allows to replace the complicated, less efficient conventional looking devices which have two stable end-positions, only one of which being stable under a voltage-free condition.

1. An electromagnetically actuated, bistable locking device comprising:
a lock pin (11) that is moveable substantially along a longitudinal axis between an extended position and a retracted position,
at least one permanent magnet (12) with two pole ends, said at least one permanent magnet mounted for rotation between a first magnetic orientation associated with an extended position of the lock pin (11) and a second magnetic orientation associated with a retracted position of the lock pin (11),
at least one electromagnet (13) having first and second ends and electromagnetically actuated in one of said extended and retracted positions of the lock pin (11) to provide a first orientation of magnetic field, and in the other of said extended and retracted positions of the lock pin (11) to provide a second orientation of magnetic field, said second orientation of magnetic field being substantially the reverse of the first orientation of the magnetic field,
a mechanical interconnection between the pin lock (11) and the at least one permanent magnet (12) for moving said pin lock (11) between the extended and the retracted positions of the lock pin (11) at the actuation of the electromagnet (13), and
wherein each of the at least one permanent magnet (12) is arranged adjacent to the first end of the respective one of the at least one electromagnet (13),
characterized in that the mechanical interconnection comprises:
a rotatable crank-shaft (15) extending perpendicularly to said longitudinal axis of the lock pin (11), and to which the at least one permanent magnet (12) is rigidly mounted, said crank-shaft (15) having at least one eccentric section to which the lock pin (11) is pivotably coupled, and
guiding means for guiding the lock pin (11) substantially along said longitudinal axis.

2. The locking device according to claim 1, characterized in that the locking device comprises two electromagnetic solenoids (13) arranged side by side, wherein a permanent magnet (12) is arranged at the first end of both electromagnetic solenoids (13), and wherein the electromagnetic solenoids (13) are connected to each other with reverse polarity, and wherein the two permanent magnets (12) are mounted to the crank-shaft (15) with reverse magnetic polarity.

3. The locking device according to claim 1, characterized in that it comprises a steel shielding housing having an aperture for allowing the ejection of the lock pin (11).

4. The locking device according to claim 1, characterized in that the at least one electromagnetic solenoid (13) is fastened to the shielding housing, and the crank-shaft (15) is adapted to move in a guided manner, in parallel to the longitudinal axis of the lock pin (11).

5. The locking device according to claim 1, characterized in that the at least one electromagnetic solenoid (13) is adapted to move in a direction parallel to the longitudinal axis of the lock pin (11) and the rotational axis of the crank-shaft (15) is stationary.
